(19) United States
(12) Patent Application Publication
(10) Pub. No.: US 2011/0135945 A1
(43) Pub. Date: Jun. 9, 2011

(54) MESOSTRUCTURED COATINGS COMPRISING A SPECIFIC TEXTURE AGENT FOR APPLICATION IN AERONAUTICS AND AEROSPACE

(75) Inventors: Sophie Monredon-Senani, Paris (FR); Elisa Campazzi, Boulogne-Billancourt (FR); Clement Sanchez, Bures Sur Yvette (FR); Lionel Nicole, Brunoy (FR); Francois Ribot, Bourg-la-Reine (FR)

(73) Assignees: EURO. AERONAUTIC DEFENCE AND SPACE CO. EADS FRANCE, PARIS (FR); UNIVERSITE PARIS 6 PIERRE ET MARIE CURIE, PARIS (FR); CENTRE NATIONAL DE LA RECHERCHE SCI. (CNRS), PARIS CEDEX 16 (FR)

(21) Appl. No.: 12/936,272

(22) PCT Filed: Apr. 3, 2009
(86) PCT No.: PCT/FR09/50576

§ 371 Date: Feb. 18, 2011

(30) Foreign Application Priority Data
Apr. 4, 2008 (FR) 0852269

(51) Int. Cl. B32B 15/04; B05D 1/36; B05D 1/38; B05D 1/02; B05D 1/28; B05D 1/18; B05D 3/02; B05D 3/10; B05D 3/06; B05D 7/14; B05D 7/24; B05D 5/00

(52) U.S. Cl. 428/447; 427/240; 427/402; 427/427.5; 427/429; 427/435; 427/372.2; 427/331; 427/553; 427/558

(57) ABSTRACT

The invention relates to a structure comprising: at least one mesostructured layer, prepared by a sol/gel method from at least one specific metallic molecular precursor in the presence of a specific texturing agent and a metal substrate. The invention further relates to the method for production and use thereof in aeronautics and aerospace.

The present invention relates to a structure comprising a mesostructured coating which comprises a specific texturing agent, intended to be used in aeronautical and aerospace applications.

In the aeronautical field, corrosion protection is generally provided by surface treatments based on chromium VI, for example, by means of a method of chromic anodic oxidation, or a conversion layer.

However, it has been found that chromium VI is toxic, carcinogenic and dangerous to the environment. Its use should eventually be banned.

There is therefore a need to find another system providing protection, for example against corrosion but also against scratches or scuffing etc., which offers performance at least as good as the existing systems.

Hybrid organic/inorganic materials prepared by a sol-gel process have already been proposed in industry.

For example, document US 2003/024432 describes a coating that has anticorrosion properties, prepared by a sol-gel process from an organometallic compound such as an alkoxyzirconium, from an organosilane, and from one or more compounds bearing a borate, zinc or phosphate function, in the presence of an organic catalyst such as acetic acid.

Documents U.S. Pat. No. 6,261,638 and EP 1 097 259 in their turn describe methods for preventing corrosion of metals, comprising the application of a treatment solution based on polyfunctional silanes and bifunctional silanes having several sulfur atoms in their chain, respectively.

However, these materials have the drawback that they are not micro- or nanostructured, i.e. the distribution of the organic and inorganic domains in the material cannot be controlled on the micrometric or nanometric scale. This random distribution can result in properties that are not reproducible from one material to another.

One advantage of the sol-gel process consists in constructing a three-dimensional network from starting precursors in so-called mild conditions, i.e. at a temperature below 200° C., and in a water or water/solvent medium that is less harmful to the environment than those used for the conventional surface treatments.

The starting precursors generally used in said sol-gel process are metal alkoxides comprising one or more hydrolyzable groups.

Other types of so-called mesostructured coatings possessing anticorrosion properties were recently described in the article “TiOx self-assembled networks prepared by templating approach as nanostructured reservoirs for self-healing anticorrosion pre-treatments”, by S. V. Lamaka et al., Electrochemistry Communications 8, 2006, 421-428.

However, these coatings are prepared from a titanium alkoxide, leading to a photocatalytic material that degrades rapidly when it is exposed to sunlight.

The applicant discovered, surprisingly, that controlling the nature of the organic/inorganic interfaces on the nanometric scale made it possible, with certain materials, to achieve better performance in terms of macroscopic properties such as corrosion resistance, resistance to scratching and scuffing, mechanical durability, thickness and quality of the film, density, coloration and hydrophobic character that could be modulated as desired, and in terms of repeatability.

This control is achieved with structures comprising at least one specific mesostructured layer and a metallic substrate.

Hybrid and inorganic mesostructured layers are notably known and described in the article “Mesostructured hybrid organic-inorganic thin films”, by L. Nicole et al., J. Mater. Chem., 2005, 15, 3598-3627.

These mesostructured layers possess controlled porosity, i.e. a pore size between 2 and 50 nm, measured for example by adsorption-desorption of gases, and are structured on the nanometric scale.

They are obtained starting from sol-gel precursors and surface-active molecules. This particular combination makes it possible to construct an inorganic or hybrid network around the micelles of surface-active molecules. A mesostructured material is then obtained, in which the micelles of surface-active molecules serve as templates whose structures are well recorded, such as those described for example in “Surfactants: A Practical Handbook” by K. Robert Lange, Hanser Gardner Publications, or in “Surfactant Science and Technology” by Drew Myers, Wiley-VCH, or in “Chemical strategies to design textured materials: from microporous and mesoporous oxides to nanonetworks and hierarchical structures. ” by Soler-Illia, G. J. A. A., Sanchez, C., Lebeau, B. and Patarin, J., Chemical Reviews 102, 4093-4138 (2002).

These mesostructured layers can bear various functionalities which can endow a metallic substrate (or surface), notably an alloy of aluminum, of titanium or of magnesium, or a steel, for example, with corrosion protection, resistance to scratching and scuffing, good mechanical durability and/or coloration and/or can constitute a probe for quality control, while offering good adherence to the metallic substrate.

Moreover, these layers can permit the coexistence of several different functionalities and can be deposited by any conventional technique such as, for example, dip-coating, spin-coating, sprinkling, spraying, laminar coating and application by brush. The individual components can be designed so as to have a service life compatible with industrial cycles, for example greater than or equal to 12 months, and can be mixed just before they are applied. Their formulation offers the additional advantage that it uses components that are compatible with environmental regulations, and notably is predominantly in an aqueous medium.

The present invention therefore relates to a structure comprising:
a metallic substrate,
at least one mesostructured layer as defined hereunder,
   and
optionally at least one dense layer.

Said mesostructured layer(s) is/are prepared by a sol-gel process from at least one molecular metallic precursor comprising one or more hydrolyzable groups, of formula (1), (2), (3) or (4) defined hereunder, in the presence of at least one specific texturing agent as defined hereunder. The texturing agent is retained in the final material and endows it with at least one macroscopic property, and optionally that of a latex.

This preparation by a sol-gel process is generally carried out in the presence of water and optionally of at least one volatile solvent such as an alcohol, such as ethanol and propanol, tetrahydrofuran, acetone, dioxane, a diether, chloroform or acetonitrile.

“Hydrolyzable group” means a group capable of reacting with water to give a group —OH, which will itself undergo polycondensation.

Said metallic molecular precursor(s) bearing one or more hydrolyzable groups are of the metal alkoxide or halide type, preferably metal alkoxide, or alkynylmetal of formula:

MZₙ (1)

L^{m}ₓMZₙ₋ₘₓ (2)

R′_{x′}M′Z_{4-x′} (3) or

Z₃M′-R″-M′Z₃ (4)

In formulas (1), (2), (3) and (4):
M represents Al(III), Ce(III), Ce(IV), Si(IV), Zr(IV), Sn(IV), Hf(IV), Nb(V), V(V) or Ta(V), preferably Al(III), Ce(III), Ce(IV), Si(IV), Zr(IV), Sn(IV) or Nb(V), or a rare earth such as Y(III), La(III) and Eu(III), the figure in parentheses being the valence of the atom M;
n represents the valence of the atom M;
x is an integer in the range from 1 to n−1;
M′ represents Si(IV) or Sn(IV);
x′ is an integer in the range from 1 to 3;
in the case when M or M′ does not denote Sn, each Z represents, independently of one another, a halogen atom or a group —OR, and preferably a group —OR;
in the case when M or M′ denotes Sn, each Z represents, independently of one another, a halogen atom or a group —OR, and preferably a group —OR, or an alkynyl group —C≡C—R′″ where R′″ represents a hydrogen atom, an alkyl group preferably of C₁₋₁₀, such as a methyl or butyl group, a C₆₋₁₀ aryl group, such as a phenyl group, a C₇₋₁₆ alkaryl or aralkyl group such as a benzyl group;
R represents an alkyl group preferably comprising 1 to 4 carbon atoms, such as a methyl, ethyl, n-propyl, i-propyl, n-butyl, s-butyl or t-butyl group, preferably methyl, ethyl or i-propyl, more preferably ethyl;
each R′ represents, independently of one another, a nonhydrolyzable group selected from the alkyl groups, notably C₁₋₄, for example methyl, ethyl, propyl or butyl; the alkenyl groups in particular of C₂₋₄, such as vinyl, 1-propenyl, 2-propenyl and butenyl; the alkynyl groups in particular of C₂₋₄, such as acetylenyl and propargyl; the aryl groups in particular of C₆₋₁₀, such as phenyl and naphthyl; the methacryl or methacryloxy(C₁₋₁₀ alkyl) groups such as methacryloxypropyl; the epoxyalkyl or epoxyalkoxyalkyl groups in which the alkyl group is linear, branched or cyclic, of C₁₋₁₀, and the alkoxy group has from 1 to 10 carbon atoms, such as glycidyl and glycidyloxy(C₁₋₁₀ alkyl); the C₂₋₁₀ haloalkyl groups such as 3-chloropropyl; the C₂₋₁₀ perhaloalkyl groups such as perfluoropropyl; the C₂₋₁₀ mercaptoalkyl groups such as mercaptopropyl; the C₂₋₁₀ aminoalkyl groups such as 3-aminopropyl; the (C₂₋₁₀ aminoalkyl)amino(C₂₋₁₀ alkyl) groups such as 3-[(2-aminoethyl)amino]propyl; the di(C₂₋₁₀ to alkylene)triamino(C₂₋₁₀ alkyl) groups such as 3-[diethylenetriamino]propyl and the imidazolyl(C₂₋₁₀ alkyl) groups;
L represents a monodentate or polydentate, preferably polydentate, complexing ligand, for example a carboxylic acid preferably of C₁₋₁₈, such as acetic acid, a β-diketone preferably of C₅₋₂₀, such as acetylacetone, a β-ketoester preferably of C₅₋₂₀, such as methyl acetoacetate, a β-ketoamide preferably of C₅₋₂₀, such as an N-methylacetoacetamide, an α- or β-hydroxyacid preferably of C₃₋₂₀, such as lactic acid or salicylic acid, an amino acid such as alanine, a polyamine such as diethylenetriamine (or DETA), or phosphonic acid or a phosphonate;
m represents the hydroxylation index of the ligand L; and
R″ represents a nonhydrolyzable function selected from the alkylene groups preferably of C₁₋₁₂, for example methylene, ethylene, propylene, butylene, hexylene, octylene, decylene and dodecylene; the alkynylene groups preferably of C₁₋₁₂, for example acetylenylene (—C≡C—), —C≡C—C≡C—, and —C≡C—C₆H₄—C≡C—; the N,N-di(C₂₋₁₀ alkylene)amino groups such as N,N-diethylene amino; the bis[N,N-di(C₂₋₁₀ alkylene)amino] groups such as bis[N-(3-propylene)-N-methylene amino]; C₂₋₁₀ mercaptoalkylene such as mercaptopropylene; the (C₂₋₁₀ alkylene)polysulfide groups such as propylene disulfide or propylene tetrasulfide; the alkenylene groups in particular of C₂₋₄, such as vinylene; the arylene groups in particular of C₆₋₁₀, such as phenylene; the di(C₂₋₁₀ alkylene)-(C₆₋₁₀ arylene) groups, such as di(ethylene)phenylene; the N,N′-di(C₂₋₁₀ alkylene)ureido groups such as N,N′-dipropyleneureido; and the following groups:
   of thiophene types such as

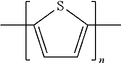

with n=1-4,
of (poly)ether or (poly)thioether types, aliphatic and arylic, of C₂₋₅₀ such as —(CH₂)ₚ—X—(CH₂)ₚ—, —(CH₂)ₚ—C₆H₄—X—C₆H₄—(CH₂)ₚ—, C₆H₄—X—C₆H₄—, and —[(CH₂)ₚ—X]_{q}(CH₂)ₚ—, with X representing O or S, p=1-4 and q=2-10,
of crown ether types such as

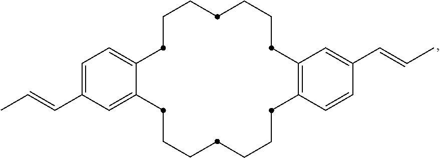

of organosilane types such as:
   —CH₂CH₂—SiMe₂—C₆H₄—SiMe₂—CH₂CH₂—,
   —CH₂CH₂—SiMe₂—C₆H₄—O—C₆H₄—SiMe₂—CH₂CH₂— and
   —CH₂CH₂—SiMe₂—C₂H₄—SiMe₂—CH₂CH₂—,
of C₁₋₁₈ fluoroalkylene types such as —(CF₂)ᵣ— with r=1-10, —CH₂CH₂—(CF₂)₆—CH₂CH₂— and —(CH₂)₄—(CF₂)₁₀—(CH₂)₄—,
of the Viologen type

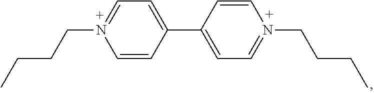

or
of the trans-1,2-bis(4-pyridylpropyl)ethene type

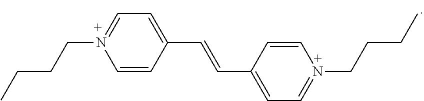

Preferably M is different from Si for formula (2).

As examples of compounds of formula (1), we may notably mention tetra(C₁₋₄ alkoxy)silanes and zirconium n-propoxide Zr(OCH₂CH₂CH₃)₄.

As examples of compounds of formula (2), we may notably mention:
aluminum di-s-butoxy-ethylacetoacetate
   (CH₃CH₂OC(O)CHC(O)CH₃)Al(CH₃CHOCH₂CH₃)₂,
bis(2,4-pentanedionate)zirconium dichloride
   [CH₃C(O)CHC(O)CH₃]₂ZrCl₂,
diispropoxy-bis(2,2,6,6-tetramethyl-3,5-heptanedionate)zirconium
   [(CH₃)₃CC(O)CHC(O)C(CH₃)₃]₂Zr[OCH(CH₃)₂]₂, and
bis(2,4-pentanedionato)dichlorotin
   [CH₃C(O)CHC(O)CH₃]₂SnCl₂

As examples of organoalkoxysilane of formula (3), we may notably mention 3-aminopropyltrialkoxysilane (RO)₃Si—(CH₂)₃—NH₂, 3-(2-aminoethyl)aminopropyltrialkoxysilane (RO)₃Si—(CH₂)₃—NH—(CH₂)₂—NH₂, 3-(trialkoxysilyl)propyldiethylenetriamine (RO)₃Si—(CH₂)₃—NH—(CH₂)₂—NH—(CH₂)₂—NH₂; 3-chloropropyltrialkoxysilane (RO)₃Si—(CH₂)₃Cl, 3-mercaptopropyltrialkoxysilane (RO)₃Si—(CH₂)₃SH; organosilylated azoles of the N-(3-trialkoxysilylpropyl)-4,5-dihydroimidazole type, with R having the same meaning as above.

As other examples of compound of formula (3), we may also mention trichlorobutyltin CH₃CH₂CH₂CH₂SnCl₃, tris(isopropoxy)butyltin CH₃CH₂CH₂CH₂Sn[OCH(CH₃)₂]₃, tris(2-phenylacetylene)methyltin CH₃Sn—(C≡C—C₆H₅)₃, and tris(propynyl)butyltin CH₃CH₂CH₂CH₂Sn—(C≡C—CH₃)₃.

As examples of bis-alkoxysilane of formula (4), it is preferable to use a bis[trialkoxysilyl]methane (RO)₃Si—CH₂—Si(OR)₃, a bis[trialkoxysilyl]ethane (RO)₃Si—(CH₂)₂—Si(OR)₃, a bis[trialkoxysilyl]octane (RO)₃Si—(CH₂)₈—Si(OR)₃, a bis[trialkoxysilylpropyl]amine (RO)₃Si—(CH₂)₃—NH—(CH₂)₃—Si(OR)₃, a bis-[trialkoxysilylpropyl]ethylenediamine (RO)₃Si—(CH₂)₃—NH—(CH₂)₂—NH—(CH₂)₃—Si(OR)₃; a bis-[trialkoxysilylpropyl]disulfide (RO)₃Si—(CH₂)₃—S₂—(CH₂)₃—Si(OR)₃, a bis[trialkoxysilylpropyl]tetrasulfide (RO)₃Si—(CH₂)₃—S₄—(CH₂)₃—Si(OR)₃, a bis-[trialkoxysilylpropyl]urea (RO)₃Si—(CH₂)₃—NH—CO—NH—(CH₂)₃—Si(OR)₃; a bis[trialkoxysilylether]phenyl (RO)₃Si—(CH₂)₂—C₆H₄—(CH₂)₂—Si(OR)₃, with R having the same meaning as above.

As other examples of compound of formula (4), we may also mention bis(trichlorotin)phenyl Cl₃Sn—C₆H₄—SnCl₃ or bis(tripropynyltin)butane (CH₃—C≡C)₃—Sn—(CH₂)₄—Sn—(C≡C—CH₃)₃.

Said texturing agent(s) used in the present invention is/are selected from:
elementary nanoblocks in the form of clusters or nanoparticles, essentially based on at least one metal oxide, preferably functionalized with organic compounds that may or may not be active against corrosion,
ionic amphiphilic surfactants such as anionic and cationic, in which the counterion is selected from Nd³⁺, Pr³⁺, Co³⁺, Ce³⁺ and Ce⁴⁺ when the surfactant is anionic, and from the vanadate, molybdate and permanganate anions when the surfactant is cationic, and
amphiphilic surfactants additionally bearing:
   one or more active organic anticorrosion functions, and/or
   one or more complexing groups of metal ions.

The elementary nanoblocks that can be used as structuring agents are materials that are well known and are described notably in the article “Designed hybrid organic-inorganic nanocomposites from functional nanobuilding blocks” by C. Sanchez et al., Chem. Mater., 2001, 13, 3061-3083.

The elementary nanoblocks used in the present invention are in the form of clusters or nanoparticles, preferably nanoparticles with a size in the range from 2 to 100 nm, better still from 2 to 50 nm, even better from 2 to 20 nm, more preferably from 2 to 10 nm and even more preferably from 2 to 5 nm, and the diameter of these nanoparticles can be measured by transmission electron microscopy (or TEM), X-ray diffraction and small-angle X-ray scattering or scattering of light.

Preferably, the nanoparticles have a small size distribution.

These elementary nanoblocks are essentially based on at least one metal oxide, the metal oxide being selected for example from the oxides of aluminum, of cerium III and IV, of silicon, of zirconium, of titanium and of tin, more preferably from the oxides of zirconium and of cerium IV. Several methods of synthesis can be used for preparing them.

A first method consists of synthesizing them from metal salts, by precipitation. Complexing agents can be introduced into the reaction mixture to control the size of the elementary nanoblocks formed and ensure that they are dispersed in the solvent by functionalization of the surface of the nanoblocks with monodentate or polydentate complexing agents, for example carboxylic acid, β-diketone, β-ketoester, α- or β-hydroxyacid, phosphonate, polyamine and amino acid. The weight ratio of mineral to organic components is notably between 20 and 95%.

The elementary nanoblocks can also be obtained from at least one metal alkoxide or metal halide, preferably metal alkoxide, by hydrolytic or nonhydrolytic processes. In the case of a hydrolytic process, controlled hydrolysis is performed on at least one metal alkoxide or metal halide precursor of general formula:

M₁(Z₁)ₙ₁, (5),

(L₁^{m1})_{x1′}M₁(Z₁)_{4-m1x1′} (6) or

(R₁′)ₓ₁M₁′(Z₁)ₙ₁₋ₓ₁ (7).

In formulas (5), (6) and (7):
M₁ represents Al(III), Ce(III), Ce(IV), Si(IV), Zr(IV), Ti(IV) or Sn(IV), preferably Zr(IV) or Ce(IV), the figure in parentheses being the valence of the metal atom,
M₁′ represents Si(IV) or Sn(IV),
n₁ represents the valence of the atom M₁,
x₁ is an integer in the range from 1 to n₁−1,
x₁′ is an integer in the range from 1 to 3,
Z₁ represents a halogen atom or —OR₁, preferably —OR₁;
R₁ represents an alkyl group, preferably comprising 1 to 4 carbon atoms, such as a methyl, ethyl, n-propyl, i-propyl or butyl group, preferably methyl or ethyl;
R₁′ represents a nonhydrolyzable group selected from the alkyl groups notably of C₁₋₄, for example methyl, ethyl, propyl or butyl; the alkenyl groups in particular of C₂₋₄, such as vinyl, 1-propenyl, 2-propenyl and butenyl; the alkynyl groups in particular of C₂₋₄, such as acetylenyl and propargyl; the aryl groups in particular of C₆₋₁₀, such as phenyl and naphthyl; the methacryl or methacryloxy(C₁₋₁₀ alkyl) groups such as methacryloxypropyl; and the epoxyalkyl or epoxyalkoxyalkyl groups in which the alkyl group is linear, branched or cyclic, of C₁₋₁₀, and the alkoxy group has from 1 to 10 carbon atoms, such as glycidyl and glycidyloxy(C₁₋₁₀ alkyl);
L₁ is a monodentate or polydentate, preferably polydentate, complexing ligand, for example, for example, a carboxylic acid preferably of C₁₋₁₈, such as acetic acid, a β-diketone preferably of C₅₋₂₀, such as acetylacetone, a β-ketoester preferably of C₅₋₂₀, such as methyl acetoacetate, a β-ketoamide preferably of C₅₋₂₀, such as an N-methylacetoamide, an α- or β-hydroxyacid preferably of C₅₋₂₀, such as lactic acid or salicylic acid, an amino acid such as alanine, a polyamine such as diethylenetriamine (or DETA), or phosphonic acid or a phosphonate; and
m₁ represents the hydroxylation index of the ligand L₁.

“Controlled hydrolysis” means a limitation of the growth of the species formed by controlling the amount of water introduced into the mixture and optionally by introducing a complexing agent of the central metal atom, in order to reduce the reactivity of the precursors.

The elementary nanoblocks used in the present invention are preferably in the form of amorphous or crystalline nanoparticles, and can be functionalized on the surface with a functionalizing agent for NBB.

They are functionalized either directly in the course of their synthesis, or in the course of a second stage following their synthesis, in the presence of a functionalizing agent for NBB, and preferably in the course of a second stage. This is called pre- or post-functionalization, respectively.

Post-functionalization can be carried out chemically, by selecting a bifunctional molecule as functionalizing agent for NBB, for which one of the functions has strong affinity for the surface of the elementary nanoblock and the other function can interact with the matrix but will display little or no affinity for the surface of the elementary nanoblock. Chemical functionalization thus makes it possible to modify the surface of the nanoblocks, notably by simple mixing of a solution containing the elementary nanoblocks with a solution containing the functionalizing agent for NBB.

As examples of functions displaying affinity for the surface of the nanoblock, we may notably mention a carboxylic acid function, a diketone function or a phosphate or phosphonate function.

As examples of functions that can interact with the matrix, we may notably mention the primary, secondary or tertiary amino groups such as C₁₋₈ alkylamino, and the polymerizable functions such as vinyl, acrylate or methacrylate.

As examples of bifunctional molecules used as functionalizing agent for NBB, we may notably mention 6-aminocaproic acid and 2-aminoethylphosphonic acid.

Preferably, the degree of functionalization is greater than or equal to 20%.

The elementary nanoblocks can also be functionalized with complexing agents comprising one or more metal complexing groups as defined hereunder, bound to a C₁₋₂₀ alkyl group. These complexing molecules are preferably arranged around these nanoblocks as a monolayer. A second layer will be constituted of amphiphilic surfactants, preferably ionic. The counterion of the ionic surfactants will preferably be cations Nd³⁺, Pr³⁺, Co³⁺, Ce³⁺, Ce⁴⁺ for an anionic surfactant or the vanadate, molybdate, permanganate anions for a cationic surfactant.

The amphiphilic surfactant or surfactants that can be used in the invention as texturing agents are ionic amphiphilic surfactants such as anionic or cationic, amphoteric or zwitterionic, or nonionic, and can moreover be photo- or thermo-polymerizable. This surfactant can be an amphiphilic molecule or a macromolecule (or polymer) having an amphiphilic structure.

The anionic surfactants preferably used in the present invention are anionic amphiphilic molecules such as phosphates, for example C₁₂H₂₅OPO₃H₂; sulfates, for example CₚH₂ₚ₊₁OSO₃Na with p=12, 14, 16 or 18; sulfonates, for example C₁₆H₃₃SO₃H and C₁₂H₂₅C₆H₄SO₃Na, and the carboxylic acids, for example stearic acid C₁₇H₃₅CO₂H.

As examples of cationic amphiphilic surfactant, we may notably mention the quaternary ammonium salts such as those of formula (I) below, or salts of imidazolium or of pyridinium, or of phosphonium.

Particular quaternary ammonium salts are notably selected from those corresponding to the following general formula (I):

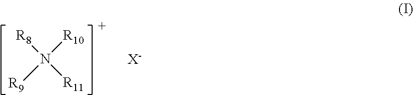

in which the radicals R₈ to R₁₁, which may be identical or different, represent a linear or branched alkyl group, having from 1 to 30 carbon atoms, and X represents a halogen atom such as an atom of chlorine or of bromine, or a sulfate.

Among the quaternary ammonium salts of formula (I), we may notably mention the tetraalkylammonium halides, for example the dialkyldimethylammonium or alkyltrimethylammonium halides in which the alkyl radical has about 12 to 22 carbon atoms, in particular the halides of behenyltrimethylammonium, of distearyldimethylammonium, of cetyltrimethylammonium, of benzyldimethylstearylammonium. The preferred halides are the chlorides and bromides.

As examples of amphoteric or zwitterionic amphiphilic surfactant, we may notably mention the amino acids such as the propionic amino acids of formula (R₁₂)₃N⁺—CH₂—CH₂—COO⁻ in which each R₁₂, identical or different, represents a hydrogen atom or a C₁₋₂₀ alkyl group such as dodecyl, and more particularly dodecyl propionic amino acid.

The nonionic molecular amphiphilic surfactants usable in the present invention are preferably linear ethoxylated C₁₂₋₂₂ alcohols, having from 2 to 30 ethylene oxide units, or esters of fatty acids having from 12 to 22 carbon atoms, and sorbitan. We may notably mention as examples those sold under the trade names Brij®, Span® and Tween® by the company Aldrich, and for example, Brij® 56 and 78, Tween® 20 and Span® 80.

The nonionic polymeric amphiphilic surfactants are any amphiphilic polymer possessing both a hydrophilic character and a hydrophobic character. As examples of said copolymers, we may notably mention:
fluorinated copolymers CH₃—[CH₂—CH₂—CH₂—CH₂—O]ₙ—CO—R₁, with R₁═C₄F₉ or C₈F₁₇,
biological copolymers such as polyamino acids, for example, a polylysine and the alginates,
dendrimers such as those described in G. J. A. A. Soler-Illia, L. Rozes, M. K. Boggiano, C. Sanchez, C. O. Turrin, A. M. Caminade, J. P. Majoral, Angew. Chem. Int. Ed. 2000, 39, No. 23, 4250-4254, and for example (S═)P[O—C₆H₄—CH═N—N(CH₃)—P(═S)—[O—C₆H₄—CH═CH—C(═O)—OH]₂]₃,
block copolymers comprising two blocks, three blocks of the type A-B-A or A-B-C or four blocks, and
any other copolymer of amphiphilic character known by a person skilled in the art, and more particularly those described in Adv. Mater., S. Förster, M. Antonietti, 1998, 10, 195-217 or Angew. Chem. Int., S. Förster, T. Plantenberg, Ed, 2002, 41, 688-714, or Macromol. Rapid Commun, H. Cölfen, 2001, 22, 219-252.

Preferably, within the scope of the present invention, an amphiphilic block copolymer is used, of the type:
copolymer based on poly((meth)acrylic acid),
copolymer based on polydiene,
copolymer based on hydrogenated diene,
copolymer based on poly(propylene oxide),
copolymers based on poly(ethylene oxide),
copolymer based on polyisobutylene,
copolymer based on polystyrene,
copolymer based on polysiloxane,
copolymer based on poly(2-vinyl-naphthalene),
copolymer based on poly(vinyl pyridine and N-methyl vinyl pyridinium iodide),
copolymer based on poly(vinyl pyrrolidone).

Preferably a block copolymer is used that is constituted of poly(alkylene oxide) chains, each block being constituted of a poly(alkylene oxide) chain, the alkylene having a different number of carbon atoms for each chain.

For example, for a copolymer with two blocks, one of the two blocks is constituted of a poly(alkylene oxide) chain of hydrophilic nature and the other block is constituted of a poly(alkylene oxide) chain of hydrophobic nature. For a copolymer with three blocks, two of the blocks are of hydrophilic nature whereas the other block, located between the two hydrophilic blocks, is of hydrophobic nature. Preferably, in the case of a copolymer with three blocks, the poly(alkylene oxide) chains of hydrophilic nature are poly(ethylene oxide) chains designated (POE)ᵤ and (POE)_{w} and the poly(alkylene oxide) chains of hydrophobic nature are poly(propylene oxide) chains designated (POP)ᵥ or poly(butylene oxide) chains, or else mixed chains in which each chain is a mixture of several monomers of alkylene oxides. In the case of a copolymer with three blocks, it is possible to use a compound of formula (POE)ᵤ-(POP)ᵥ-(POE)_{w} with 5<u<106, 33<v<70 and 5<w<106. As an example, Pluronic® P123 (u=w=20 and v=70) or Pluronic® F127 (u=w=106 and v=70) is used, these products being sold by the company BASF or Aldrich.

When the amphiphilic surfactants are ionic such as anionic and cationic, the counterion can be selected from Nd³⁺, Pr³⁺, Co³⁺, Ce³⁺ and Ce⁴⁺ when the surfactant is anionic, and from the vanadate, molybdate and permanganate anions when the surfactant is cationic.

The texturing agent usable in the invention can also be an amphiphilic surfactant bearing in addition:
one or more active organic anticorrosion functions, and/or
one or more complexing groups of metal ions.

As examples of active organic anticorrosion functions, we may notably mention benzotriazole, 2-mercaptobenzothiazole, mercaptobenzimidazole, sodium benzoate, nitrochlorobenzene, chloranyl, 8-hydroxyquinoline, N-methylpyridine, piperidine, piperazine, 1,2-aminoethylpiperidine, N-2-aminoethylpiperazine, N-methylphenothiazine, imidazole or pyridine. These functions are bound directly or indirectly, via a group having from 2 to 30 ethylene oxide units, to a C₁₋₂₀ alkyl group. In the case of ionic surfactants, the counterion of the surfactant will preferably be at least one of the cations Nd³⁺, Pr³⁺, Co³⁺, Ce³⁺, Ce⁴⁺ for an anionic surfactant or at least one of the vanadate, molybdate, permanganate anions for a cationic surfactant.

“Complexing group of metal ions” means any chelating or polydendate group having one or more functions selected from —OH, —COOH, —NH₂, ═NOH, —SH, —PO₃H₂, —PO₂H, ═O, ═S, ═N—, —NH— and able to form a dative or coordination bond with a metal ion, for example aluminum, this group preferably being a hydrocarbon group, saturated or unsaturated, linear or branched C₁ to C₆ or cyclic C₃ to C₆ substituted with one or more of the aforementioned functions. These groups are bound directly or indirectly, via a group bearing from 2 to 30 ethylene oxide units, to a C₁₋₂₀ alkyl group. In the case of ionic surfactants, the counterion of the surfactant will preferably be at least one of the cations Nd³⁺, Pr³⁺, Co³⁺, Ce³⁺, Ce⁴⁺ for an anionic surfactant or at least one of the vanadate, molybdate, permanganate anions for a cationic surfactant.

As examples of surfactants usable in the present invention, we may notably mention benzotriazole-5-carboxylic acid esterified with polyoxyethylated cetyl ether which corresponds to the formula CH₃—(CH₂)₁₅—O(CH₂—CH₂—O)₂₀—C(O)—C₆H₃N₃H, 1-hexadecyl-3-methylimidazolium vanadate or 3-methyl-l-octylpyridinium molybdate.

The texturing agent or agents are preferably used in an amount in the range from 0.001 to 2 mol. % relative to the total number of moles of the molecular metallic precursor(s). The total number of moles of the molecular metallic precursor(s) comprises the total number of moles of the molecular metallic precursor(s) of formulas (1) to (4).

Other ingredients such as a latex can also be added during preparation of the mesostructured layer.

The mesostructured layer can additionally possess at least one other functionality different from corrosion resistance, i.e. it can additionally comprise groups conferring macroscopic properties on the substrate, such as resistance to scratching and scuffing, mechanical durability and hydrophobic character that can be varied as required, and/or groups constituting a probe for quality control.

“Probe” means for example an optical probe, a probe that is sensitive to pH, a dye or a fluorescent probe that is selective for specific cations or anions.

This functionalization results either from the presence, in at least one starting molecular metallic precursor of formula (2), (3) or (4), of a group R′, L and/or R″ representing a group that confers a functionality (or group that confers a function on the mesostructured layer), or from adding at least one functionalizing agent during preparation of the mesostructured layer or treatment of the mesostructured layer with at least one functionalizing agent after its production, or a combination of these three possibilities.

Functionalizing agent means, in the sense of the present invention, an agent that endows the mesostructured layer with a function, such as resistance to scratching and scuffing or mechanical durability, or constituting a fluorescent probe for detecting halogenated compounds, a probe that is sensitive to pH, or conferring a coloration.

It is possible to use, as agent conferring resistance to scratching and scuffing, a titanium or aluminum alkoxide, or nanoparticles of silica or alumina.

As examples of agent conferring mechanical durability, we may notably mention zirconium oxide.

The agent constituting a fluorescent probe for detecting halogenated compounds can be constituted of an anthracene molecule bearing imidazolium groups.

Methyl orange or phenolphthalein can preferably be used as an agent constituting a probe that is sensitive to pH.

As examples of agent conferring a coloration, we may notably mention rhodamine, fluorescein, quinizarine, methylene blue and ethyl violet.

In a preferred embodiment of the invention, the starting components are added in the following order, during preparation of the mesostructured layer:
(1) an optional volatile solvent, preferably an alcohol such as ethanol,
(2) the texturing agent or agents as defined above,
(3) water,
(4) the molecular metallic precursor(s) selected from those of formulas (1), (2), (3) and (4), as defined above,
(5) optionally the functionalizing agent or agents, and optionally a latex, and
(6) an acid so that the measurement of pH of the medium with an electrode is between 0 and 4,
   and the solution is stirred for a length of time between 2h and 15 days, preferably between 40 hours and 6 days.

The structure can comprise several mesostructured layers, for example from 2 to 10 layers, with different mesostructures if required. For example, in the case of four mesoporous layers having filled or unfilled porosities, P1, P2, P3 and P4, respectively, the latter are between 2 and 50 nm, P1>P2>P3>P4, the layer having a porosity P1 being in direct contact with the substrate or the nearest to the substrate.

In another embodiment, the structure has a porosity gradient in a single, same mesostructured layer.

The metallic substrate that can be used in the present invention is preferably of titanium, of aluminum or one of their respective alloys, for example titanium TA6V, aluminum of the family 2000, more particularly Al 2024 plated or unplated, aluminum of the family 7000, more particularly Al 7075 or 7175 and aluminum of the family 6000 or 5000, or of stainless steel, for example 35 NCD 16 or 15-5 PH, or of magnesium alloy.

The mesostructured layer is deposited by means of techniques that are simple to apply on the metallic substrates, for example by dip-coating, spin-coating, sprinkling, spraying, laminar coating or application by brush, and preferably by spraying. Moreover, these techniques use environmentally friendly products.

The structures thus obtained notably display corrosion resistance, resistance to scratching and scuffing, coloration and/or a hydrophobic character that can be modulated as desired, with good adherence being observed between the mesostructured layer or layers and the metallic substrate.

In one embodiment of the invention, the structure further comprises at least one dense layer prepared by a sol-gel process, such as a layer described in French patent application No. 2 899 906.

“Dense layer” means a layer that does not have porosity on the micrometric and mesoscopic scale and visible with the electron microscope, and more particularly having a porosity less than 1 nm, measured by adsorption-desorption of gas.

The dense layer is notably prepared by a sol-gel process from at least one metal alkoxide or halide, preferably at least one metal alkoxide, as defined above by formulas (5) to (7).

Said additional dense layer preferably comprises elementary nanoblocks (or nanobuilding blocks (NBB)) as defined above, and a polymeric or organic/inorganic hybrid matrix.

Once the elementary nanoblocks have been synthesized and optionally functionalized as indicated above, they are introduced into a polymeric or inorganic/organic hybrid matrix, preferably hybrid of the sol-gel type, more preferably based on silica, and even more preferably constituted of silica or of silica/zirconium oxide. This matrix will serve as a linker, by which the elementary nanoblocks will form a three-dimensional network.

The inorganic/organic hybrid matrices are notably obtained by polycondensation of one or more metal alkoxides or metal halides, preferably of one or more metal alkoxides, in the presence of a solvent, and optionally of a catalyst. The metal alkoxides or metal halides used are notably selected from those having the general formulas:

M₂(Z₂)ₙ₂ l (8)

(L₂^{m2})ₓ₂M₂(Z₂)ₙ₂₋ₘ₂ₓ₂ (9)

(R₂)ₓ₂M₂′(Z₂)ₙ₂₋ₓ₂ (10)

(Z₂)ₙ₂₋₁M₂′-R₃-M₂′(Z₂)ₙ₂₋₁ (11)

in which:

n₂ represents the valence of the metal atom M₂, preferably 3, 4 or 5;

x₂ is an integer in the range from 1 to n₂−1;

M₂ represents a metal atom of valence III such as Al; a metal atom of valence IV such as Si, Ce, Zr and Ti; or a metal atom of valence V such as Nb. Preferably M₂ is silicon (n₂=4), cerium (n₂=4) or zirconium (n₂=4), and even more preferably silicon;

M₂′ represents a silicon atom,
Z₂ represents a hydrolyzable group selected from halogen atoms; alkoxy groups preferably of C₁₋₄, such as methoxy, ethoxy, n-propoxy, i-propoxy and butoxy; aryloxy groups in particular of C₆₋₁₀, such as phenoxy; and C₁₋₁₀ alkylcarbonyl groups such as acetyl. Preferably, Z₂ represents a C₁₋₄ alkoxy group, and more particularly a methoxy, ethoxy, i-propoxy, n-butoxy, s-butoxy, i-butoxy or t-butoxy group;

R₂ represents a nonhydrolyzable monovalent group selected from alkyl groups preferably of C₁₋₄, for example, methyl, ethyl, propyl and butyl; alkenyl groups in particular of C₂₋₄, such as vinyl, 1-propenyl, 2-propenyl and butenyl; alkynyl groups in particular of C₂₋₄ such as acetylenyl and propargyl; aryl groups in particular of C₆₋₁₀, such as phenyl and naphthyl; methacryl and methacryloxy(C₁₋₁₀ alkyl) groups such as methacryloxypropyl; and epoxyalkyl or epoxyalkoxyalkyl groups in which the alkyl group is linear, branched or cyclic, of C₁₋₁₀, and the alkoxy group has from 1 to 10 carbon atoms, such as glycidyl and glycidyloxy(C₁₋₁₀ alkyl). R₂ preferably represents a methyl or glycidyloxy(C₁₋₁₀ alkyl) group as glycidyloxypropyl;

R₃ represents a nonhydrolyzable divalent group such as that described for R″; and

L₂ represents a complexing ligand such as that described for L₁ above, and

m₂ represents the hydroxylation index of the ligand L₂.

The solvent used in the preparation of the matrix is constituted predominantly of water. Preferably, it comprises 80 to 100 wt. % of water relative to the total weight of the solvent, and optionally a C₁₋₄ alcohol, preferably ethanol or isopropanol.

The catalyst is preferably an acid, more preferably acetic acid, or CO₂.

At least one additive can optionally be added, either during preparation of the elementary nanoblocks, or during mixing of the functionalized elementary nanoblocks and the matrix, or during both these stages.

In the case when an additive is added during preparation of the elementary nanoblocks, a final material can be formed of the core/shell type, the core being constituted of the additive and the shell being constituted of an elementary nanoblock.

The additives that can be used in the invention are notably surfactants for improving the wettability of the sol on the mesoporous functional layer(s) already present, or of the metallic substrate, such as the nonionic fluorinated polymers sold under the brand names FC 4432 and FC4430 by the 3M company; dyes, for example rhodamine, fluorescein, methylene blue and ethyl violet; crosslinking agents such as diethylenetriamine (or DETA); coupling agents such as aminopropyltriethoxysilane (APTS); nanopigments, or mixtures thereof.

Said dense layer, preferably comprising elementary nanoblocks and an organic/inorganic hybrid matrix, is obtained in particular, on the one hand:
by preparing the elementary nanoblocks, notably by a hydrolytic or nonhydrolytic process as described above, and
optionally functionalizing them,
   and on the other hand
by preparing the matrix,
   then
mixing the optionally functionalized elementary nanoblocks and the matrix.

It can moreover be deposited according to one of the techniques described above for deposition of the mesostructured layer.

In the case when said additional dense layer(s) is/are present, the mesostructured layer is preferably in direct contact with the substrate and thus plays the role of nanoreservoir of active compounds.

In another embodiment, a layer such as a dense layer or a native layer or of some other nature, can be situated between the substrate and a first mesostructured layer as defined in the invention.

In particular, the structure comprises a multilayer coating comprising at least one mesostructured layer as described above, more particularly at least two layers which comprise at least one mesostructured layer and optionally at least one dense layer as described above, preferably from 2 to 10, more preferably from 2 to 5 layers. The total thickness of this multilayer coating is preferably in the range from 1 to 10 μm.

Another object of the present invention is a method of preparation of a structure as defined above, comprising the stages consisting of:
(a) preparing a sol-gel material by hydrolysis-condensation of at least one molecular metallic precursor of formula (1), (2), (3) or (4) as defined above, in aqueous medium or water/volatile solvent, preferably water/alcohol, and more preferably water/ethanol, in the presence of acid, of at least one functional texturing agent as defined above, and optionally of at least one additional functionalizing agent, and optionally in the presence of a latex,
(b) depositing the material obtained in stage (a) on a coated or uncoated metallic substrate, for example by dip-coating, spin-coating, sprinkling, spraying, laminar coating or application by brush,
(c) optionally treating the coated substrate thermally, chemically, for example with ammonia vapor, or by UV, or combining the three treatments, leading to densification of the network, and
(d) optionally repeating stages (b) and (c), or (a) to (c).

The volatile solvent can be an alcohol such as ethanol or propanol, tetrahydrofuran, acetone, dioxane, a di-ether, chloroform or acetonitrile.

In a preferred embodiment of the invention, preparation of the sol-gel material in stage (a) is carried out by adding the starting components in the following order:
(1) an optional volatile solvent, preferably an alcohol such as ethanol,
(2) the texturing agent or agents as defined above,
(3) water,
(4) the molecular metallic precursor(s) selected from those of formulas (1), (2), (3) and (4), as defined above,
(5) optionally the functionalizing agent or agents, and optionally a latex, and
(6) an acid so that measurement of the pH of the medium with an electrode is between 0 and 4,
   and the solution is stirred for a duration between 2 h and 15 days, preferably between 40 hours and 6 days.

The solution thus obtained can be stored in a cool place for several weeks, preferably 4 weeks.

The texturing agent or agents is/are preferably used in an amount in the range from 0.001 to 2 mol. % relative to the total number of moles of the molecular metallic precursor(s).

The method can further comprise stages of deposition of a dense layer as defined above from a composition comprising the mixture of optionally functionalized elementary nanoblocks and a matrix, according to a well-known technique such as dip-coating, spin-coating, sprinkling, spraying, laminar coating or application by brush.

The invention further relates to the use of the mesostructured layer as defined in the invention for improving the corrosion resistance, resistance to scratching and scuffing, mechanical durability, as a probe, the coloration and/or hydrophobic character of a metallic substrate in the aeronautical or aerospace field.

The invention and the advantages that it offers will be better understood from the examples given below for purposes of illustration.

### EXAMPLES

### Example 1

5 mol of water, 0.15 mol of orthophosphoric acid (H₃PO₄), 0.06 mol of surfactant CH₃—(CH₂)₁₅—O(CH₂—CH₂—O)₂₀—C(O)—C₆H₃N₃H and 1 mol of tetraethoxysilane (TEOS) were added successively to 20 mol of ethanol, while stirring. Between each addition, the solution was stirred for a few minutes to obtain a homogeneous solution.

After addition of TEOS, the solution was stirred at room temperature for about 42 hours.

In addition, a substrate of unplated alloy Al 2024 T3, with the dimensions 80*40*1.6 mm, was prepared according to methodology known by a person skilled in the art, such as alkaline degreasing followed by chemical acid pickling, with a formulation compatible with environmental regulations.

A film was deposited on the metallic substrate by dip-coating of said substrate in the solution with a rate of withdrawal of 3.4 mm·s⁻¹, in controlled ambient conditions (T=20-22° C., relative humidity (or RH)=40-45%). Immediately after deposition, the film was left to dry in ambient conditions.

### Example 2

5 mol of water, 0.005 mol of surfactant sold under the trade name Pluronic F127, 0.1 mol of benzotriazole, 0.1 mol of cerium (III) nitrate, 0.15 mol of orthophosphoric acid (H₃PO₄) and 1 mol of tetraethoxysilane (TEOS) were added successively to 20 mol of ethanol, while stirring. Between each addition, the solution was stirred for a few minutes to obtain a homogeneous solution.

After addition of the TEOS, the solution was stirred at room temperature for about 42 hours.

Moreover, a substrate of unplated alloy Al 2024 T3, with the dimensions 80*40*1.6 mm, was prepared according to methodology known by a person skilled in the art, such as alkaline degreasing followed by chemical acid pickling, with a formulation compatible with environmental regulations.

A film was deposited on the metallic substrate by dip-coating of said substrate in the solution with a rate of withdrawal of 3.4 mm·s⁻¹, in controlled ambient conditions (T=20-22° C., relative humidity (or RH)=60%). Immediately after deposition, the film was left to dry in ambient conditions.

1. A structure comprising:
a metallic substrate, and
at least one mesostructured layer prepared by a sol-gel process from at least one molecular metallic precursor comprising one or more hydrolyzable groups of the metal alkoxide or halide type, preferably metal alkoxide, or alkynylmetal of formula:
MZₙ (1),
L^{m}ₓMZₙ₋ₘₓ (2)
R′_{x′}M′Z₄₋ₓ (3) or
Z₃M′-R″-M^{′Z}₃ (4)
where, in formulas (1), (2), (3) and (4):
M represents Al(III), Ce(III), Ce(IV), Si(IV), Zr(IV), Sn(IV), Hf(IV), Nb(V), V(V), Ta(V) or a rare earth, the figure in parentheses being the valence of the atom M;
n represents the valence of the atom M;
x is an integer in the range from 1 to n−1;
M′ represents Si(IV) or Sn(IV);
x′ is an integer in the range from 1 to 3;
in the case when M or M′ does not denote Sn, each Z represents, independently of one another, a halogen atom or a group —OR;
in the case when M or M′ denotes Sn, each Z represents, independently of one another, a halogen atom or a group —OR, or an alkynyl group —C≡C—R′″ where R′″ represents an alkyl group preferably of C₁₋₁₀, a C₆₋₁₀ aryl group or a C₇₋₁₆ alkaryl or aralkyl group;
R represents an alkyl group preferably having 1 to 4 carbon atoms;
each R′ represents, independently of one another, a nonhydrolyzable group selected from the alkyl groups notably of C₁₋₄; the alkenyl groups in particular of C₂₋₄; the alkynyl groups in particular of C₂₋₄; the aryl groups in particular of C₆₋₁₀; the methacryl or methacryloxy(C₁₋₁₀ alkyl) groups; the epoxyalkyl or epoxyalkoxyalkyl groups in which the alkyl group is linear, branched or cyclic, of C₁₋₁₀, and the alkoxy group has from 1 to 10 carbon atoms; the C₂₋₁₀ haloalkyl groups; the C₂₋₁₀ perhaloalkyl groups; the C₂₋₁₀ mercaptoalkyl groups; the C₂₋₁₀ aminoalkyl groups; the (C₂₋₁₀ aminoalkyl)amino(C₂₋₁₀ alkyl) groups; the di(C₂₋₁₀ alkylene)triamino(C₂₋₁₀ alkyl) groups and the imidazolyl-(C₂₋₁₀ alkyl) groups;
L represents a monodentate or polydentate, preferably polydentate, complexing ligand,
m represents the hydroxylation index of the ligand L; and
R″ represents a nonhydrolyzable function selected from the alkylene groups preferably of C₁₋₁₂, alkynylene preferably of C₁₋₁₂, N,N-di(C₂₋₁₀ alkylene)amino, bis[N,N-di(C₂₋₁₀ alkylene)amino], C₂-₁₀ mercaptoalkylene, (C₂₋₁₀ alkylene)polysulfide, alkenylene in particular of C₂₋₄, arylene in particular of C₆₋₁₀, di(C₂₋₁₀ alkylene)arylene of C₆₋₁₀, N,N′-di(C₂₋₁₀ alkylene)ureido and the following groups:
of thiophene types,
of (poly)ether or (poly)thioether types, aliphatic and arylic, of C₂₋₂₀,
of crown ether types,
of organosilane type,
of C₁₋₁₈ fluoroalkylene types,
of the Viologen type 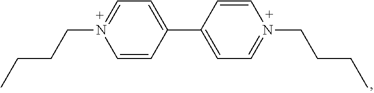
or
of trans-1,2-bis(4-pyridylpropyl)ethene type 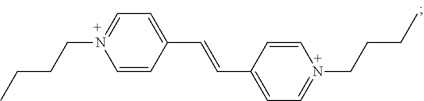
in the presence of at least one texturing agent selected from:
elementary nanoblocks in the form of clusters or nanoparticles, essentially based on at least one metal oxide,
ionic amphiphilic surfactants in which the counterion is selected from Nd³⁺, Pr³⁺, Co³⁺, Ce³⁺ and Ce⁴⁺ when the surfactant is anionic, and from the vanadate, molybdate and permanganate anions when the surfactant is cationic, and
the amphiphilic surfactants bearing in addition:
one or more active organic anticorrosion functions, and/or
one or more complexing groups of metal ions.

2. The structure as claimed in claim 1, characterized in that M is selected from Al(III), Ce(III), Ce(IV), Si(IV), Zr(IV), Sn(IV), Nb(V), Y(III), La(III) and Eu(III).

3. The structure as claimed in claim 1 or 2, characterized in that R is selected from the methyl, ethyl, n-propyl, i-propyl, n-butyl, s-butyl and t-butyl groups.

4. The structure as claimed in any one of the preceding claims, characterized in that R′ is selected from the methyl, ethyl, propyl, butyl, vinyl, 1-propenyl, 2-propenyl, butenyl, acetylenyl, propargyl, phenyl, naphthyl, methacryl, methacryloxypropyl, glycidyl, glycidyloxy(C₁₋₁₀ alkyl), 3-chloropropyl, perfluoropropyl, mercaptopropyl, 3-aminopropyl, 3-[(2-aminoethyl)amino]propyl and 3-[diethylenetriamine]propyl groups.

5. The structure as claimed in any one of the preceding claims, characterized in that R″ is selected from the groups methylene, ethylene, propylene, butylene, hexylene, octylene, decylene, dodecylene, acetylenylene (—C═C—), —C≡C—C≡C—, —C≡C—C₆H₄—C≡C—, N,N-diethylene amino, bis[N-(3-propylene)-N-methylene amino], mercaptopropylene, propylene disulfide, propylene tetrasulfide, vinylene, phenylene, di(ethylene)phenylene, N,N′-dipropyleneureido, 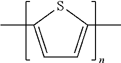
with n=1-4, —(CH₂)ₚ—X—(CH₂)ₚ—, —(CH₂)ₚ—C₆H₄—X—C₆H₄—(CH₂)ₚ—, —C₆H₄—X—C₆H₄—, and —[(CH₂)ₚ—X]_{q}(CH₂)ₚ—, with X representing O or S, p=1-4 and q=2-10, 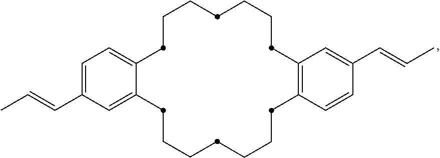
—CH₂CH₂—SiMe₂—C₆H₄—SiMe₂—CH₂CH₂—, —CH₂CH₂—SiMe₂—C₆H₄—O—C₆H₄—SiMe₂—CH₂CH₂—, —CH₂CH₂—SiMe₂—C₂H₄—SiMe₂—CH₂CH₂—, —(CF₂)ᵣ— with r=1-10, —CH₂CH₂—(CF₂)₆—CH₂CH₂—, —(CH₂)₄—(CF₂)₁₀—(CH₂)₄—,

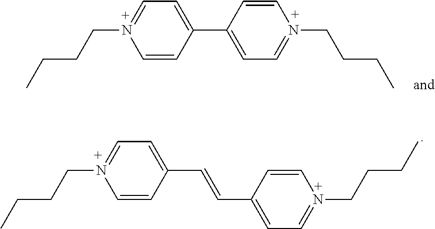

6. The structure as claimed in any one of the preceding claims, characterized in that the elementary nanoblocks are in the form of nanoparticles with a size in the range from 2 to 100 nm.

7. The structure as claimed in any one of the preceding claims, characterized in that the elementary nanoblocks are essentially based on at least one metal oxide, the metal oxide being selected from the oxides of aluminum, of cerium III and IV, of silicon, of zirconium, of titanium and of tin.

8. The structure as claimed in any one of the preceding claims, characterized in that the elementary nanoblocks are obtained by controlled hydrolysis of at least one precursor metal alkoxide or metal halide of general formula:
M₁(Z₁)ₙ₁, (5),
(L₁^{m1})ₓ₁, M₁(Z₁)_{4-m1x1′} (6) or
(R₁′)ₓ₁(Z₁)ₙ₁₋ₓ₁ (7)
where, in formulas (5), (6) and (7):
M₁ represents Al(III), Ce(III), Ce(IV), Si(IV), Zr(IV), Ti(IV) or Sn(IV), the figure in parentheses being the valence of the metal atom,
M₁′ represents Si(IV) or Sn(IV),
n₁ represents the valence of the atom M₁,
x₁ is an integer in the range from 1 to n₁−1,
x₁′ is an integer in the range from 1 to 3,
Z₁ represents a halogen atom or —OR₁;
R₁ represents an alkyl group preferably comprising 1 to 4 carbon atoms;
R₁′ represents a nonhydrolyzable group selected from the alkyl groups notably of C₁₋₄, alkenyl groups in particular of C₂₋₄, alkynyl groups in particular of C₂₋₄, aryl groups in particular of C₆₋₁₀, methacryl or methacryloxy(C₁₋₁₀ alkyl) groups, and epoxyalkyl or epoxyalkoxyalkyl groups in which the alkyl group is linear, branched or cyclic, of C₁₋₁₀, and the alkoxy group has from 1 to 10 carbon atoms;
L₁ is a monodentate or polydentate complexing ligand, preferably polydentate; and
m₁ represents the hydroxylation index of the ligand L₁.

9. The structure as claimed in claim 7 or 8, characterized in that R₁ represents a methyl, ethyl, n-propyl, i-propyl or butyl group.

10. The structure as claimed in claim 8 or 9, characterized in that R₁′ represents a methyl, ethyl, propyl, butyl, vinyl, 1-propenyl, 2-propenyl, butenyl, acetylenyl, propargyl, phenyl, naphthyl, methacryloxypropyl, glycidyl or glycidyloxy(C₁₋₁₀ alkyl) group.

11. The structure as claimed in any one of the preceding claims, characterized in that L or L₁ represents a carboxylic acid, a β-diketone, a β-ketoester, a β-ketoamide, an α- or β-hydroxyacid, an amino acid, a polyamine, phosphonic acid or a phosphonate.

12. The structure as claimed in any one of the preceding claims, characterized in that the elementary nanoblocks are functionalized on the surface with a functionalizing agent for elementary nanoblocks (NBB).

13. The structure as claimed in claim 12, characterized in that the functionalizing agent for NBB is selected from 6-aminocaproic acid, 2-aminoethylphosphonic acid and complexing agents comprising one or more metal complexing groups.

14. The structure as claimed in any one of the preceding claims, characterized in that the active organic anticorrosion function or functions of an amphiphilic surfactant is/are selected from benzotriazole, 2-mercaptobenzothiazole, mercaptobenzimidazole, sodium benzoate, nitrochlorobenzene, chloranyl, 8-hydroxyquinoline, N-methylpyridine, piperidine, piperazine, 1,2-aminoethylpiperidine, N-2-aminoethylpiperazine, N-methylphenothiazine, imidazole and pyridine, and is/are bound directly or indirectly, via a group comprising from 2 to 30 ethylene oxide units, to a C₁₋₂₀ alkyl group.

15. The structure as claimed in any one of the preceding claims, characterized in that the complexing group(s) of metal ions of an amphiphilic surfactant is/are selected from a saturated or unsaturated hydrocarbon group, linear or branched of C₁ to C₆ or cyclic of C₃ to C₆ substituted with one or more of the functions selected from —OH, —COOH, —NH₂, ═NOH, —SH, —PO₃H₂, —PO₂H, ═O, ═S, ═N—, —NH—, said group or groups being bound directly or indirectly, via a group comprising from 2 to 30 ethylene oxide units, to a C₁₋₂₀ alkyl group.

16. The structure as claimed in any one of the preceding claims, characterized in that the amphiphilic surfactant is ionic and the counterion is at least one of the cations Nd³⁺, Pr³⁺, Co³⁺, Ce³⁺, Ce⁴⁺ if it is anionic or at least one of the vanadate, molybdate, permanganate anions if it is cationic.

17. The structure as claimed in any one of the preceding claims, characterized in that the amphiphilic surfactant is selected from the polyoxyethylated cetyl ether that corresponds to the formula CH₃—(CH₂)₁₅—O(CH₂—CH₂—O)₂₀—C(O)—C₆H₃N₃H, 1-hexadecyl-3-methylimidazolium vanadate and 3-methyl-l-octylpyridinium molybdate.

18. The structure as claimed in any one of the preceding claims, characterized in that the metallic substrate is of titanium, of aluminum or one of their alloys, of stainless steel or of magnesium alloy.

19. The structure as claimed in any one of the preceding claims, characterized in that the structure comprises at least one dense layer prepared by a sol-gel process.

20. The structure as claimed in claim 19, characterized in that the dense layer comprises elementary nanoblocks as defined in any one of claims 7 to 13, and a polymeric or organic/inorganic hybrid matrix.

21. The structure as claimed in claim 20, characterized in that the matrix is obtained by polycondensation of one or more metal alkoxides or metal halides, preferably of one or more metal alkoxides, in the presence of a solvent, and optionally of a catalyst.

22. The structure as claimed in claim 21, characterized in that the metal alkoxides or metal halides are selected from those having the general formulas:
M₂(Z₂)ₙ₂ (8)
(L₂^{m2})ₓ₂M₂(Z₂)ₙ₂₋ₘ₂ₓ₂ (9)
(R₂)ₓ₂M₂′(Z₂)ₙ₂₋ₓ₂ (10)
(Z₂)ₙ₂₋₁M₂′-R₃-M₂′(Z₂)ₙ₂₋₁ (11)
in which:
n₂ represents the valence of the metal atom M₂, preferably 3, 4 or 5;
x₂ is an integer in the range from 1 to n₂−1;
M₂ represents a metal atom of valence III, IV or V;
M₂′ represents a silicon atom,
Z₂ represents a hydrolyzable group selected from halogen atoms, alkoxy groups preferably of C₁₋₄, aryloxy groups in particular of C₆₋₁₀, and C₁₋₁₀ alkylcarbonyl groups;
R₂ represents a nonhydrolyzable monovalent group selected from alkyl groups preferably of C₁₋₄, alkenyl groups in particular of C₂₋₄, alkynyl groups in particular of C₂₋₄, aryl groups in particular of C₆₋₁₀, methacryl and methacryloxy(C₁₋₁₀ alkyl) groups, and epoxyalkyl or epoxyalkoxyalkyl groups in which the alkyl group is linear, branched or cyclic, of C₁₋₁₀, and the alkoxy group has from 1 to 10 carbon atoms;
R₃ represents a nonhydrolyzable divalent group selected from the alkylene groups preferably of C₁₋₁₂, alkynylene preferably of C₁₋₁₂, N,N-di(C₂₋₁₀ alkylene)amino, bis[N,N-di(C₂₋₁₀ alkylene)amino], C₂₋₁₀ mercaptoalkylene, (C₂₋₁₀ alkylene)polysulfide, alkenylene in particular of C₂₋₄, arylene in particular of C₆₋₁₀, di(C₂₋₁₀ alkylene)arylene of C₆₋₁₀, N,N′-di(C₂₋₁₀ alkylene)ureido and the following groups:
of thiophene types,
of (poly)ether or (poly)thioether types, aliphatic and arylic, of C₂₋₂₀,
of crown ether types,
of the organosilane type,
of C₁₋₁₈ fluoroalkylene types,
of the Viologen type 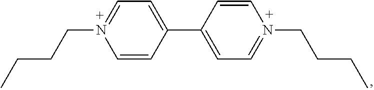
or
of the trans-1,2-bis(4-pyridylpropyl)ethene type 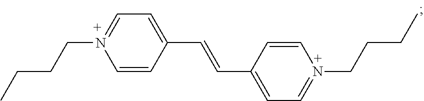
and
L₂ represents a monodentate or polydentate, preferably polydentate, complexing ligand, and
m₂ represents the hydroxylation index of the ligand L₂.

23. A method for preparing a structure as defined in any one of the preceding claims, comprising the stages consisting of:
(a) preparing a sol-gel material by hydrolysis-condensation of at least one molecular metallic precursor of formula (1), (2), (3) or (4) as defined in claim 1, in aqueous medium or water/volatile solvent, preferably water/alcohol, in the presence of acid, of at least one functional texturing agent as defined in any one of the claims 1 and 14 to 17, and optionally of at least one additional functionalizing agent, and optionally in the presence of a latex,
(b) depositing the material obtained in stage (a) on a metallic substrate, for example by dip-coating, deposition on a coated or uncoated substrate, by spin-coating, sprinkling, spraying, laminar coating or application by brush,
(c) optionally treating the coated substrate thermally, chemically or by UV, or combining the three treatments, leading to a densification of the network, and
(d) optionally repeating stages (b) and (c), or (a) to (c).

24. The use of the mesostructured layer as defined in any one of claims 1 to 17, for improving the corrosion resistance, resistance to scratching and scuffing, mechanical durability, use as a probe, the coloration and/or the hydrophobic character of a metallic substrate in the aeronautical or aerospace field.
